(19) United States
(12) Patent Application Publication
(10) Pub. No.: US 2022/0275186 A1
(43) Pub. Date: Sep. 1, 2022

(54) ABS MOLDING MATERIAL OBTAINED BY MASS OR SOLUTION POLYMERIZATION

(71) Applicant: INEOS STYROLUTION GROUP GMBH, Frankfurt am Main (DE)

(72) Inventors: Norbert NIESSNER, Friedelsheim (DE); Gisbert MICHELS, Leverkusen (DE); Walter DE VET, BJ Gilze (NL)

(21) Appl. No.: 17/637,867

(22) PCT Filed: Aug. 27, 2020
(86) PCT No.: PCT/EP2020/073923

§ 371 Date: Feb. 24, 2022

(30) Foreign Application Priority Data
Aug. 30, 2019 (EP) 19194553.4

(51) Int. Cl. C08L 25/12

(52) U.S. Cl. CPC C08L 25/12

(57) ABSTRACT

Acrylonitrile-Butadiene-Styrene molding compositions having improved organoleptic properties comprising a rubber modified vinylaromatic copolymer composition obtained by mass (bulk) or solution polymerization in a continuous process, and use of these molding compositions for various applications (e.g. automotive parts) are described.

The present invention relates to ABS (Acrylonitrile-Butadiene-Styrene) molding compositions having improved organoleptic properties comprising a rubber modified vinylaromatic (ABS) copolymer composition, obtained by mass (bulk) or solution polymerization in a continuous process, and to the use of said molding compositions for various applications.

The preparation of impact ABS molding materials by mass or solution polymerization is known for many years. Recently, in particular the automotive industry is looking for ABS for interior parts (consoles, knobs, etc.) following more and more stringent rules on residual monomers and, as a result, on low “volatile organic compounds” (VOC) migrating out of the ABS plastic part. A major purpose for this requirement is the demand for ABS with benign organoleptic behavior for the automotive interior sector. This means to have low odor and low smell, together with low gloss for minimized optical reflections in the automotive interior.

The mechanical properties of ABS molding materials polymerized in bulk or solution on the one hand and prepared in emulsion on the other hand are substantially similar. The advantages of bulk or solution polymers are, in particular, the lower preparation costs (inter alia higher rubber effectiveness, no effluent) and paler inherent color of the polymer product, which consumes less pigment(s) for coloration.

Mass-ABS products have the advantage of lower surface gloss since the bulk- or solution-polymerized ABS often contains relatively large dispersed rubber particles (often average particle size more than 1000 nm).

U.S. Pat. Nos. 5,250,611, 5,278,253 and 5,387,650 disclose a continuous process for the preparation of a high-impact polystyrene-acrylonitrile molding materials whose dispersed polybutadiene rubber particles have diameters of less than 500 nm, by bulk or solution polymerization in at least two or more reaction zones, namely in consecutive reactors with cooling tubes and stirrer at 50 to 170° C. using a free-radical initiator (0.01 to 0.5 wt.-% based on monomers) and preferably a chain-transfer agent (regulator 0.01 to 0.5 wt.-%), phase inversion taking place in one of the reactors. In a first step a rubber solution is prepared by adding styrene and acrylonitrile to a polybutadiene rubber. Then, said rubber solution is fed to a first reactor to which a radical initiator (TBPND or TBPPI) is added at temperatures of 80° C.

A chain transfer agent is added during polymerization. 1 to 3 further reactors are used for the polymerization at temperatures of 130 to 146° C. The products obtained according to said prior art however have a low gloss. Furthermore, said documents are silent about the odor of the products and thus give no indication how to keep the smell of polymer compositions and parts low.

Thus, it is an objective of the present invention to provide a matte and low gloss ABS (thermoplastic) molding composition prepared by a continuous mass or solution polymerization process which has improved organoleptic properties. Moreover, it is desired that the ABS material can be prepared and processed easily and without complicated technical steps.

It was found that these objectives are achieved by ABS molding compositions according to the claims. One aspect of the invention is a molding composition comprising (consisting of):
a) a rubber modified vinylaromatic copolymer composition A) (component A), composed of a matrix phase comprising a copolymer of monomers B1) and B2), and a dispersed phase comprising particles of graft rubber copolymer C′) composed of rubber polymer C) (=graft base) with grafts built up from (parts or portions) monomers B1) and B2), obtained by mass (bulk) or solution polymerization of monomers B1) and B2)
   B1: 50 to 85 wt.-%, preferably 59 to 70 wt.-%, based on B1), B2) and C), of at least one vinylaromatic monomer B1), preferably styrene and/or alpha-methylstyrene;
   B2: 10 to 40 wt.-%, preferably 19 to 30 wt.-%,—based on B1), B2) and C)—of at least one comonomer B2) different from B1), preferably (meth)acrylonitrile;
   in a continuous process in the presence of:
      C: 5 to 20 wt.-%, preferably 11 to 18 wt.-%,—based on B1), B2) and C)—of a rubber polymer C) made from:
      C1: 30 to 100 wt.-%, preferably 70 to 100 wt.-%—based on C1) and C2)—of a conjugated diene C1), preferably 1,3-butadiene and/or isoprene;
      C2: 0 to 70 wt.-%, preferably 0 to 30 wt.-%,—based on C1) and C2)—of at least one comonomer, preferably styrene;
   where the sum of components B1), B2) and C) is 100 wt.-%, and
b) 0 to 20 pbw, based on 100 pbw A), of at least one pigment D), and
c) 0 to 10 pbw, based on 100 pbw of A), of at least one additive and/or processing aid E), different from component D);
   wherein the molding composition is further characterized by:
   a mean weight particle size of graft rubber copolymer C′) of more than 0.5 μm;
   a melt volume rate MVR (220° C./10 kg) according to ISO 1133-1:2011 of more than 3 ml/10 min, preferably more than 5 ml/10 min;
   a content of residual volatile organic compounds (monomers and solvents) of not more than 500 ppm; and
   an amount of sulfur-containing chain transfer agent, preferably of tert.-dodecylmercaptane, measured in a sulphur content of less than 500 ppm.

The term “wt.-%” is identical to “% by weight”. The term “pbw” is identical to “parts by weight”.

In the context of the invention the mean weight particle size was determined via OsO₄ stained electron photomicrographs and a mathematical algorithm correcting for microtoming particles in random sections between the poles and the equator of a particle.

A preferred rubber modified vinylaromatic copolymer composition A) is obtained by mass (bulk) or solution polymerization of:
B1: 59 to 70 wt.-%,—based on B1), B2) and C)—of at least one vinylaromatic monomer B1), preferably styrene and/or alpha-methylstyrene, in particular styrene;
B2: 19 to 30 wt.-%,—based on B1), B2) and C)—of at least one comonomer B2) different from B1), preferably (meth)acrylonitrile, in particular acrylonitrile;
   in a continuous process in the presence of
C: 11 to 18 wt.-%,—based on B1), B2) and C)—of a rubber polymer C).

Said mass (bulk) or solution polymerization process for the preparation of the molding composition according to the invention is characterized by:
i) dissolving rubber polymer C) in monomer(s) B1) and, optionally B2) and/or a solvent, by agitation of the slurry, thereafter addition of remaining comonomer B2) and optionally a solvent to the rubber polymer solution or slurry;
ii) continuously feeding the solution or slurry obtained in step i) into a first agitated reactor, preferably a continuously stirred tank reactor (CSTR), and carrying out a first polymerization of monomers B1) and B2) in presence of rubber polymer C) by use of radical initiator(s); and
iii) optionally continuously feeding the content of the first reactor into one or more, preferably one, further agitated reactor(s), preferably a continuously stirred tank reactor (CSTR), for a second polymerization
   followed by
iv) degassing of the polymer melt obtained in step iii) by pre-heating said polymer melt followed by devolatilization in a devolatilizing apparatus.

Component D) is at least one pigment, which, if present, is generally used in amounts of 0.05 to 20 pbw, preferably 0.10 to 10 pbw, based on 100 pbw of component A).

Component E) is at least one additive and/or processing aid, different from component D), which, if present, is generally used in amounts of preferably 0.01 to 10 pbw, preferably 0.02 to 5 pbw, based on 100 pbw of component A).

Preferred molding compositions comprise 0.10 to 10 pbw component of component E).

The rubber modified vinylaromatic copolymer composition A) is generally composed of a matrix phase comprising a copolymer of monomers B1) and B2), and a dispersed phase comprising particles of graft rubber copolymer C′) composed of rubber polymer C) (=graft base) with grafts built up from (parts or portions) monomers B1) and B2).

Suitable vinylaromatic monomers B1) are styrene, alpha-methylstyrene, o-, m- and p-methylstyrene, preferably styrene and/or alpha-methylstyrene, in particular styrene. Suitable comonomers B2) are acrylonitrile (B2.1) and/or methacrylonitrile (B2.2), which are optionally used in combination with at least one further monomer such as C₁-C₄-alkyl(meth)acrylates, maleic anhydride, N-phenyl maleimide, N-cyclohexyl maleimide and (meth)acrylamide. Preferred comonomers B2) are acrylonitrile and/or methacrylonitrile, in particular acrylonitrile.

Said comonomers B1) and B2), in particular styrene and acrylonitrile, are preferably used in a B1:B2 (weight)-ratio of from 80:20 to 70:30, more preferably from 78:22 to 72:28, and most preferably from 76:24 to 74:26.

Rubber component C1 is preferably based on 1,3-butadiene and/or isoprene, more preferably 1,3-butadiene.

Rubber component C2 preferably is at least one monomer selected from the group consisting of: styrene, α-methylstyrene, acrylonitrile, methacrylonitrile and methyl methacrylate, in particular styrene.

In case rubber component C2 is α-methylstyrene its maximum amount, based on C), is 30 wt.-%. Preferably no further rubber component C2 is used.

A particularly suitable rubber polymer C) is medium- or high-cis polybutadiene, preferably a medium-cis polybutadiene, having a molecular weight of from 70,000 to 350,000 (weight average). In the afore-mentioned process the rubber polymer C) is employed in an amount of from 5 to 20 wt.-%, preferably 11 to 18 wt.-%, based on B1), B2) and C).

Preferably at least 1 wt.-% of the particles, more preferably at least 10 wt.-% of the particles and most preferably at least 50 wt.-% of the particles of the graft rubber copolymer C′) have a mean weight particle size in the range of 0.51 to 5.00 μm, more preferably 0.51 to 3.00 μm, most preferably 0.51 to 2.00 μm.

Furthermore preferred the particles of the graft rubber copolymer C′) have a mono disperse particle size distribution.

One further aspect of the invention is the afore-mentioned mass (bulk) or solution polymerization process for the preparation of molding composition according to the invention.

Generally in step i) of the process according to the invention rubber polymer C) is used dry e.g. in the form of bales or crumbs.

In step (i) the use of a solvent is preferred. Suitable solvents are toluene, xylene, methyl ethyl ketone, tetrahydrofuran or ethylbenzene, in particular methyl ethyl ketone and/or ethylbenzene. Said solvents can be used alone or in mixture, in particular in an amount of up to 25 wt.-%, based on B1), B2) and C).

Preferably at first in step i) monomer B2) is not present, and thus rubber polymer C) is dissolved in monomer B1) only, plus preferably a solvent.

Suitable agitated reactors used in said process according to the invention (in steps (ii) and (iii)) are continuously stirred tank reactors (CSTR), static mixers (e.g. SMX Sulzer) and/or plug flow reactors. Said agitated reactors are optionally equipped with cooling devices such as overhead condensers or cooling pipes. Preferred are continuously stirred tank reactors, in particular preferred are vertical CSTRs. The agitated reactors used in steps ii) and iii) are usually employed in series.

According to one embodiment two CSTRs in series are used, in particular one CSTR is used in step ii) and one further CSTR in step iii).

According to a further embodiment three CSTRs in series are used, in particular one CSTR is used in step ii) and two further CSTRs in step iii).

Preferred radical initiator(s) are such with a half-life time of 5 min or less at temperatures of 155° C. Said radical initiators can be graft-active peroxides. More preferred are such radical initiators which produce tert-butyloxy radicals. Preferred are tert-butyl peroxy compounds such as 1,1-di(tert.butylperoxy)-3,3,5-trimethylcyclohexane (TMCH), tert-butyl perneodecanoate (TBPND) and/or tert-butyl perpivalate (TBPPI), in particular TMCH and/or TBPND.

The radical initiators are generally metered separately into the first agitated reactor in step ii) of the process according to the invention. The one or more initiators are employed in an amount of 10 to 100 mmol, preferably 20 to 80 mmol, related to 1 kg of rubber polymer C).

The first polymerization in step (ii) of the process according to the invention is preferably carried out at a temperature of 50° C. to 100° C., more preferably 60 to 90° C.

During the first polymerization (in step ii)) the rubber polymer C) is grafted with monomers B1) and B2). In the course of the first polymerization process generally a phase inversion takes place.

In the mass (bulk) or solution polymerization process, the rubber polymer C) initially dissolved in the monomers B1), B2) and an optional solvent will phase separate, forming discrete rubber polymer particles as the polymerization of monomers B1) and B2) proceeds. This process is referred to as phase inversion since the continuous phase shifts from rubber polymer C) to graft rubber copolymer particles C′) during the course of polymerization.

In the agitated reactors used in the process according to the invention the shear rate, in particular the stirring speed, is controlled in order to obtain a graft rubber copolymer C′) with a mean weight particle size of more than 0.5 μm, in particular a graft rubber copolymer C′) whereof preferably at least 1 wt.-% of the particles, more preferably at least 10 wt.-% of the particles and most preferably at least 50 wt.-% of the particles have a mean weight particle size in the range of 0.51 to 0.69 μm. The stirring speed usually is in the range of 5 to 150 rpm.

In step (ii), the first polymerization is carried out up to a conversion (=solids content) of at least 20 wt.-%, preferred at least 25 wt.-%.

Suitable chain-transfer agents (regulators) are sulfur-containing chain transfer agents such as conventional mercaptans having from 4 to 18 carbon atoms. n-Butyl mercaptan, n-octyl mercaptan and n- and t-dodecyl mercaptan have proven particularly successful.

The chain transfer agent is preferably added in step ii) and optionally in step iii) of the process according to the invention. More preferably the chain transfer agent is added in steps ii) and iii).

The total amount of the chain transfer agent is generally from 0.01 to 0.50 parts by weight (pbw), preferably from 0.12 to 0.33 pbw, most preferably 0.15 to 0.25 pbw, related to 100 pbw of the sum of B1), B2) and C).

The second polymerization in step iii) of the process according to the invention is preferably carried out at a temperature of 100° C. to 150° C., more preferably 110 to 140° C.

During the second polymerization (in step iii)) a thermal polymerization of the polymer matrix built from monomers B1) and B2) is carried out. The second polymerization (in step iii)) is carried out up to a conversion of at least 50 wt.-%, preferred at least 60 wt.-%.

According to one embodiment one CSTR is used in step ii) and one further CSTR in step iii), in which further CSTR the second polymerization (in step iii)) is carried out up to a conversion of at least 50 wt.-%, preferred at least 60 wt.-%.

Then in step iv) of the process according to the invention, the polymer melt obtained in step iii) is degassed by pre-heating said polymer melt followed by devolatilization in a devolatilizing apparatus. During devolatilization residual monomers and optional solvent can be condensed and recycled and, if present, the solvent can be fed back to feed the agitated reactors.

Suitable devolatilizing apparatuses which can be used in process step iv) are, such as, for example, partial vaporizers, partial evaporators, flat evaporators, falling strand devolatilizers, thin-film evaporators or devolatilizing extruders. Preferably in process step iv) a partial evaporator or a falling strand devolatilizer, in particular a two stage falling strand devolatilizer, is used as devolatilizing apparatus.

The pre-heating of the polymer melt in process step iv) is preferably carried out at a temperature of more than 200 C°, preferably in the range of from 230 to 320° C. The pre-heating of said polymer melt in process step iv) can be carried out in devolatilizing apparatuses as afore-mentioned which are provided with means for heating.

Often tube heat exchangers are used for pre-heating of the polymer melt in step iv). Said tube heat exchangers can be comprised in the afore-mentioned devolatilizing apparatuses.

The degassed product obtained in step iv) is then usually cooled and granulated.

In the process according to the invention optional components D) and/or E) may be used in the above mentioned amounts.

During the process steps (i), (ii), (iii), and/or (iv), often when the rubber solution is or has been prepared in process step i) or before the product melt obtained in process step iii) is degassed, optional component(s) E) and/or D) can be added to the reaction batch in the afore-mentioned amounts.

Examples of pigments suitable as component D) are titanium dioxide, phthalocyanines, ultramarine blue, iron oxides, and carbon black, and the entire class of organic and inorganic pigments.

Examples of additives and/or processing aids suitable as component E) are such as chain transfer agents, internal glidants, antioxidants and/or UV stabilizers (e.g. sterically hindered phenols, sulfur stabilizers and/or phosphorous compounds), lubricants, plasticizers and fillers and the like, and mixtures of these. Preferably chain transfer agents, antioxidants and/or UV stabilizers are used as component E).

The molding composition obtained by the process according to the invention can be subjected to conventional thermoplastic processing, i.e. by extrusion, injection molding, calendering, blow molding, compression molding or sintering.

The molding composition according to the invention has the advantage of a low odor due to a low content (not more than 500 ppm) of VOC and a low content of sulfur-containing chain transfer agents (measured in a sulfur content of less than 500 ppm), and is thus suitable for applications in the home-sector, or, in particular for automotive interior applications.

The molding composition preferably has a yellowness index of at most 25 or less (ASTM D 1925).

A further aspect of the invention is the use of the afore-described rubber-modified vinylaromatic copolymer compositions for household and automotive applications, in particular interior automotive applications. The following examples and claims illustrate the invention.

### EXAMPLES GENERAL DESCRIPTION OF THE EXPERIMENTS

The following experiments were performed in a 2-vessel-3-tower reactor cascade.

In a 250 l stainless steel vessel, rubber polymer crumbs plus stabilizer Irganox 1076 were dissolved in a mixture of styrene and ethyl benzene at 50° C., within a period of 14 to 16 hr. Via a filter with 100 μm mesh size, the obtained rubber polymer solution is pumped into a second vessel and acrylonitrile is added as co-monomer. The content of this second vessel is continuously fed into a 3-tower reactor cascade for the polymerization.

The reactor cascade consists of 3 tower reactors in series. Each of the tower reactors has a volume of 30 liter, a length/diameter (l/d) ratio of 1100/220 mm and contains on the inside horizontal, parallel layers of cooling pipes, with finger paddle agitators in between the pipes.

The first tower reactor—designated as PPT in Table 1b—acts as a reactor for the first polymerization, and is equipped with a dosing station, including static mixer, for adding mercaptane as molecular weight controller (MWC) as a 50% b.w. solution in ethyl benzene. The polymerization turnover was controlled via the amount of initiator and the temperature. The 2^{nd} and 3^{rd} tower reactors—designated as PT1 and PT2 in Table 1b—act as reactors for the 2^{nd} polymerization.

Degassing was performed through a partial evaporator under nitrogen. Vacuum was generated via a liquid ring pump.

### Variation of Rubber Polymer and Initiator

In Examples 1 to 6 (see Tables 1a and 1b below), the influence of increasing amounts of rubber component C on the behavior of polymerization process was investigated. The initiator was tert.-butyl perpivalate (=TBPPI). The rubber polymer C was a med-cis homo polybutadiene with medium solution viscosity (e.g. Buna HX 500, Diene® 35 AC10 from Lion Elastomers, Buna® CB 380 from Arlanxeo/solution viscosity 90 mPa*s). In order to obtain highly grafted polybutadiene-g-SAN rubber particles, the molecular weight of the matrix was controlled via the amount of TDDM (tert.-dodecycl mercaptane). The pre-polymerization tower reactor 1 was run at 80° C. and up to a conversion rate of 22%. Conversion was increased in tower reactors 2 and 3 to 75%.

In order to maintain the conversion in pre-polymerization tower 1, almost constant amounts of 2 (+/−0.2) mmol initiator per kg monomer (here: styrene and acrylonitrile) were required, which equals 45 to 15 mmol initiator per kg polybutadiene.

TABLE 1a
Feed composition used for polymerization of polybutadiene rubber in styrene/acrylonitrile.

| Example No. | | | 1 | 2 | 3 | 4 | 5 | 6 |
|---|---|---|---|---|---|---|---|---|
| Polybutadiene (PBu) content | | [wt.-%] | 5 | 8 | 10 | 13 | 16 | 18 |
| | Flow rate | [l/h] | 13.2 | 12.4 | 12.4 | 12.5 | 14.5 | 14.5 |
| | | kg/h | 11.2 | 11.0 | 11.0 | 11.1 | 12.9 | 12.9 |
| Zulauf | Styrene | [pbw] | 61.28 | 60.08 | 58.88 | 57.68 | 56.48 | 55.28 |
| | Acrylnitrile | [pbw] | 20.42 | 20.2 | 19.62 | 19.22 | 18.82 | 18.42 |
| | Ethyl benzene | [pbw] | 15.0 | 15.0 | 15.0 | 15.0 | 15.0 | 15.0 |
| | Irganox 1076 | [pbw] | 1.10 | 1.10 | 1.10 | 1.10 | 1.10 | 1.10 |
| | PBu | [pbw] | 3.2 | 4.80 | 6.40 | 8.0 | 9.60 | 11.20 |
| MWC* | relative to sum | [%] | 0.24 | 0.25 | 0.25 | 0.23 | 0.15 | 0.18 |
| PPT/PT1 | B1), B2), C) | | | | | | | |
| Initiator | [TBPPI] | [ml/h] | 110 | 110 | 120 | 105 | 120 | 145 |
| VPT | (3% solution) | [mmol/h] | 16.4 | 16.4 | 17.9 | 15.7 | 17.9 | 21.7 |
| | rel. to sum | [mmol/kg] | 1.7 | 1.8 | 2.0 | 1.8 | 1.8 | 2.2 |
| | B1), B2), C) | =[ppm] | 300 | 320 | 360 | 320 | 320 | 400 |
| | rel. to PBu | [mmol/kg] | 44 | 31 | 25 | 18 | 16 | 15 |
| Mole ratio | Initiator/MWC | | 0.15 | 0.15 | 0.17 | 0.16 | 0.25 | 0.26 |

MWC* = Molecular weight controller (chain transfer agent): TDDM

TABLE 1b
Process conditions used for polymerization of polybutadiene in styrene/acrylonitrile

| Example No. | | | 1 | 2 | 3 | 4 | 5 | 6 |
|---|---|---|---|---|---|---|---|---|
| | PBu-content | [wt.-%] | 5 | 8 | 10 | 13 | 16 | 18 |
| VPT | temperature | [° C.] | 76-82 | 73-83 | 68-82 | 64-82 | 66-83 | 65-83 |
| | rpm* | [1/min] | 150 | 150 | 150 | 150 | 150 | 130 |
| | solid content | [%] | 19.7 | 22.1 | 23.5 | 22.0 | 22.5 | 26.1 |
| PT1 | temperature | [° C.] | 114-124 | 111-125 | 109-125 | 111-127 | 109-130 | 110-128 |
| | rpm | [1/min] | 100 | 100 | 100 | 100 | 100 | 80 |
| | solid content | [%] | 39.8 | 41.0 | 42.8 | 43.4 | 43.3 | 44.0 |
| PT2 | temperature | [° C.] | 124-135 | 124-137 | 124-137 | 124-140 | 126-140 | 125-144 |
| | rpm | [1/min] | 15 | 15 | 15 | 15 | 15 | 15 |
| | solid content | [%] | 60.6 | 61.3 | 63.0 | 61.4 | 60.0 | 62.5 |
| degassing | Tₜₒₚ** | [° C.] | 260 | 265 | 265 | 240 | 250 | 280 |
| | Tₜₒₚ*** | [° C.] | 313 | 313 | 312 | 312 | 310 | 310 |
| | T_{medium}*** | | | | | | | |
| | vacuum | [mbar] | ~10 | ~10 | ~10 | ~10 | ~10 | ~10 |
| conversion | PPT | [%] | 20.0 | 21.5 | 21.7 | 18.1 | 17.0 | 20.1 |
| | PT1 | [%] | 24.6 | 23.6 | 24.6 | 27.8 | 27.6 | 24.3 |
| | PT2 | [%] | 25.5 | 25.3 | 24.7 | 23.4 | 23.1 | 25.8 |

rpm* = revolutions per minute
Tₜₒₚ** = temperature top part of degassing device
T_{medium}*** = temperature medium part of degassing device

Due to the specifically higher initiator concentration at lower polybutadiene content, (highly grafted) capsule particles are being formed at low polybutadiene content, while at higher polybutadiene content, the morphology turns into larger “salami type” particles.

The properties of the obtained molding composition (cp. Table 2) were determined by the following test methods:

Mean weight particle size analysis was done via OsO₄ stained electron micrograph and a mathematical algorithm correcting for microtoming particles in random sections between the poles and the equator of a particle.

The content of sulfur-containing chain transfer agent, as well as the amount of residuals were determined via Headspace GC and a capillary column, with standard-substances to define retention time and with standard heating program from 80 to 300° C.

The organoleptic properties of the samples were tested as follows:

In a 100 ml Erlenmeyer Flask, a sample of 10 g was placed and 50 ml of freshly boiling water was added.

After 5 seconds the nose of a test panel person (in total 3 persons) was placed 10 cm above the Erlenmeyer flask and the smell was scored according to following scale:
0=absolutely no smell, completely neutral
1=a slight smell
2=a significant smell, still acceptable
3=a strong smell
4=very strong, disgusting smell

The target is to stay at or better than 2.

TABLE 2
Properties of the obtained ABS polymer compositions

| Example No. | 1 Comp. | 2 Comp. | 3 Comp. | 4 | 5 | 6 |
|---|---|---|---|---|---|---|
| PBu content [wt.-%] | 5 | 8 | 10 | 13 | 16 | 18 |
| Grafted rubber C′ | 0.30 | 0.30 | 0.40 | 0.80 | 0.60 | 1.3 |
| mean weight particle size (μm) | | | | | | |
| Visual appearance of injection molded | 1 | 1 | 1 | 2-3 | 2 | 3 |
| plaque (Tmolding = 250° C.) | | | | | | |
| Glossiness (1 = high gloss in reflecting | | | | | | |
| sunlight in 75° angle to the surface, 2 = | | | | | | |
| slight haze, 3 = clearly less gloss, 4 = | | | | | | |
| almost no light reflection, 5 = no light | | | | | | |
| reflection | | | | | | |

Comp. = Comparative example

The data show that the molding compositions according to Ex. 4 to 6 have a significantly lower glossiness in comparison to the molding compositions of Comp. examples 1 to 3.

TABLE 3
Organoleptics tests of mass-ABS molding compositions

| Example | | 7 Comp. | 8 | 9 |
|---|---|---|---|---|
| total sulphur content | | 510 | 400 | 150 |
| measured (ppm) | | | | |
| mass-ABS | Polybutadiene(wt. %) | 16 | 13 | 11 |
| composition - | styrene (wt. %) | 60 | 61 | 68 |
| (wt.-% related to final | Acrylonitrile (wt. %) | 24 | 26 | 21 |
| product) | | | | |
| Organoleptics score | | 2-3 | 2 | 1 |

*based on 100 pbw of the sum of polybutadiene, styrene and acrylonitrile

The data show that the ABS molding compositions according to Examples 8 and 9 have improved organoleptic properties.

1-16. (canceled)

17. A molding composition comprising:
a) a rubber modified vinylaromatic copolymer composition A), composed of a matrix phase comprising a copolymer of monomers B1) and B2), and a dispersed phase comprising particles of graft rubber copolymer C′) composed of rubber polymer C) with grafts built up from monomers B1) and B2),
obtained by mass or solution polymerization of monomers B1) and B2)
B1: 50 to 85 wt.-%, based on B1), B2), and C), of at least one vinylaromatic monomer B1);
B2: 10 to 40 wt.-%, based on B1), B2), and C), of at least one comonomer B2) different from B1);
in a continuous process in the presence of
C: 5 to 20 wt.-%, based on B1), B2), and C), of a rubber polymer C) made from:
C1: 30 to 100 wt.-%, based on C1) and C2), of a conjugated diene C1);
C2: 0 to 70 wt.-%, based on C1) and C2), of at least one comonomer C2);
wherein the sum of components B1), B2), and C) is 100 wt.-%;
b) 0 to 20 pbw, based on 100 pbw A), of at least one pigment D); and
c) 0 to 10 pbw, based on 100 pbw of A), of at least one additive and/or processing aid E), different from component D);
wherein the molding composition is characterized by;
a mean weight particle size of graft rubber copolymer C′) of more than 0.5 μm;
a melt volume rate MVR (220° C./10 kg) according to ISO 1133-1:2011 of more than 3 ml/10 min;
a content of residual volatile organic compounds of not more than 500 ppm; and
an amount of sulfur-containing chain transfer agent measured in a sulfur content of less than 500 ppm.

18. The molding composition according to claim 17, wherein the rubber modified vinylaromatic copolymer composition A) is obtained by mass or solution polymerization of
B1: 59 to 70 wt.-%, based on B1), B2), and C), of the at least one vinylaromatic monomer B1); and
B2: 19 to 30 wt.-%, based on B1), B2), and C), of the at least one comonomer B2) different from B1);
in a continuous process in the presence of
C: 11 to 18 wt.-%, based on B1), B2), and C), of the rubber polymer C).

19. The molding composition according to claim 17 comprising 0.01 to 10 pbw of the at least one additive and/or processing aid as component E).

20. The molding composition according to claim 17, wherein at least 1 wt.-% of the particles of the graft rubber copolymer C′) have a mean weight particle size in the range of 0.51 to 5 μm.

21. The molding composition according to claim 17, wherein the graft rubber copolymer C′) has a mean weight particle size in the range of 0.51 to 2 μm.

22. The molding composition according to claim 17, wherein the particles of the graft rubber copolymer C′) have a mono disperse particle size distribution.

23. The molding composition according to claim 17, wherein the monomers B1) and B2) are used in a B1):B2) weight-ratio of from 80:20 to 70:30.

24. The molding composition according to claim 17, wherein the mass or solution polymerization process is characterized by:
i) dissolving the rubber polymer C) in monomers B1) and, optionally B2) and/or a solvent, by agitation of the slurry, thereafter addition of remaining comonomer B2) and optionally a solvent to the rubber polymer solution or slurry;
ii) continuously feeding the solution or slurry obtained in step i) into a first agitated reactor and carrying out a first polymerization of monomers B1) and B2), by use of at least one radical initiator, and
iii) optionally continuously feeding the content of the first agitated reactor into at least one further agitated reactor for a second polymerization to obtain a polymer melt; followed by
iv) degassing the polymer melt obtained in step iii) by pre-heating the polymer melt followed by devolatilization in a devolatilizing apparatus.

25. The molding composition according to claim 24, wherein:
in step ii) of the mass or solution polymerization process the first polymerization of monomers B1) and B2) in presence of rubber polymer C) is carried out at a temperature of 50° C. to 100° C.; and
in step iii) the content of the first agitated reactor is continuously fed into at least one further agitated reactor for a second polymerization at temperatures of 100° C. to 150° C.; and wherein in steps ii) and optionally iii) a chain transfer agent in total amounts of 0.01 to 0.50 pbw, related to 100 pbw of the sum of B1), B2), and C) is added.

26. The molding composition according to claim 24, wherein:
in step i) of the mass or solution polymerization process the rubber polymer C) is dissolved only in monomer B1), plus optionally a solvent.

27. The molding composition according to claim 24, wherein:
in steps ii) and iii) of the mass or solution polymerization process at least one continuously stirred tank reactor (CSTR) is used having a stirring speed in the range of 5 to 200 rpm.

28. The molding composition according to claim 24, wherein in the mass or solution polymerization process two continuously stirred tank reactors (CSTR) in series are used, wherein one CSTR is used in step ii) and one further CSTR is used in step iii).

29. The molding composition according to claim 24, wherein in the mass or solution polymerization process three CSTRs in series are used, wherein one CSTR is used in step ii) and two further CSTRs are used in step iii).

30. The molding composition according to claim 24, wherein
in step i) of the mass or solution polymerization process a solvent is used.

31. The molding composition according to claim 24, wherein
in step iv) of the mass or solution polymerization process as the devolatilizing apparatus a partial evaporator or a falling strand devolatilizer is used.

32. A method of producing household and automotive applications comprising the molding composition according to claim 17.

33. The molding composition according to claim 17, wherein the at least one vinylaromatic monomer B1) is styrene or alpha methylstyrene and the at least one comonomer B2) is (meth)acrylonitrile or acrylonitrile.

34. The molding composition according to claim 17, wherein the conjugated diene C1) is 1,3-butadiene or isoprene and the at least one comonomer C2) is styrene.

35. The molding composition according to claim 20, wherein at least 50 wt.-% of the particles of the graft rubber copolymer C′) have a mean weight particle size in the range of 0.51 to 5 μm.

36. The molding composition according to claim 23, wherein the monomer B1) is styrene and the monomer B2) is acrylonitrile.
